(19) United States
(12) Patent Application Publication
(10) Pub. No.: US 2025/0372765 A1
(43) Pub. Date: Dec. 4, 2025

(54) TRACTION BATTERY PACK THERMAL MANAGEMENT FLUID GUIDING DIVIDERS

(71) Applicant: Ford Global Technologies, LLC, Dearborn, MI (US)

(72) Inventors: Sangyeon Kim, Northville, MI (US); Nan Robarge, Saline, MI (US); Foo Chern Ting, Canton, MI (US)

(21) Appl. No.: 18/677,447

(22) Filed: May 29, 2024

(51) Int. Cl. H01M 10/6567; B60L 50/60; H01M 10/04; H01M 10/613; H01M 10/625; H01M 10/658; H01M 50/211; H01M 50/293

(52) U.S. Cl. CPC H01M 10/6567; H01M 10/0481; H01M 10/613; H01M 10/625; H01M 10/658; H01M 50/211; H01M 50/293; B60L 50/60; H01M 2220/20

(57) ABSTRACT

A traction battery pack assembly includes a cell stack within an interior of an enclosure. The cell stack includes a plurality of battery cells and a plurality of dividers disposed along a cell stack axis. The dividers extend outward from the cell stack axis further than the battery cells to provide a portion of at least one immersion coolant channel.

### TECHNICAL FIELD

This disclosure details exemplary systems that guide liquid coolant within a battery pack and, more particularly, to a system that guides the liquid coolant using dividers.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: a cell stack within an interior of an enclosure, the cell stack including a plurality of battery cells and a plurality of dividers disposed along a cell stack axis, the plurality of dividers extending outward from the cell stack axis further than the plurality of battery cells to provide a portion of at least one immersion coolant channel.

In some aspects, the techniques described herein relate to a traction battery pack assembly, wherein the plurality of dividers are aluminum.

In some aspects, the techniques described herein relate to a traction battery pack assembly, wherein the plurality of dividers establish the at least one immersion coolant channel above the plurality of battery cells.

In some aspects, the techniques described herein relate to a traction battery pack assembly, further including a liquid coolant within the at least one immersion coolant channel.

In some aspects, the techniques described herein relate to a traction battery pack assembly, further including an enclosure assembly housing the cell stack.

In some aspects, the techniques described herein relate to a traction battery pack assembly, wherein each divider in the plurality of dividers each include a sandwiched portion and a peripheral portion, the sandwiched portion sandwiched axially between axially adjacent battery cells within the plurality of battery cells, the peripheral portion disposed outside the plurality of battery cells, the peripheral portion providing a portion of the at least one immersion coolant channel.

In some aspects, the techniques described herein relate to a traction battery pack assembly, wherein the peripheral portion axially overlaps with at least some of the plurality of battery cells.

In some aspects, the techniques described herein relate to a traction battery pack assembly, wherein the peripheral portion of a first divider within the plurality of dividers overlaps with a second divider within the plurality of dividers.

In some aspects, the techniques described herein relate to a traction battery pack assembly, wherein the sandwiched portion includes at least one other immersion coolant channel that communicates a liquid coolant between axially adjacent battery cells within the plurality of battery cells.

In some aspects, the techniques described herein relate to a traction battery pack assembly, wherein the sandwiched portion includes a non-metallic thermal barrier covered by a metal or metal alloy.

In some aspects, the techniques described herein relate to a traction battery pack assembly, wherein the peripheral portion includes a first flange that extends in a first axial direction, and a second flange that extends in an opposite, second axial direction.

In some aspects, the techniques described herein relate to a traction battery pack assembly, further including at least one first compression pad disposed between the first flange and the plurality of battery cells, and at least one second compression pad disposed between the second flange and the plurality of battery cells.

In some aspects, the techniques described herein relate to a traction battery pack assembly, wherein the peripheral portion is a first peripheral portion that extends upward past the plurality of battery cells, and further including a second peripheral portion that extends downward past the plurality of battery cells, the second peripheral portion including a first flange that extends in the first axial direction, and a second flange that extends in the second axial direction.

In some aspects, the techniques described herein relate to a traction battery pack assembly, wherein the first peripheral portion, the second peripheral portion, and the sandwiched portion are portions of a singular divider structure.

In some aspects, the techniques described herein relate to a traction battery pack assembly, wherein the first flange axially overlaps with a peripheral portion of another divider within the plurality of dividers.

In some aspects, the techniques described herein relate to a traction battery pack assembly, wherein an interface between the first flange and a flange of a peripheral portion of another divider is a shiplap interface.

In some aspects, the techniques described herein relate to a method of managing thermal energy within a traction battery pack, including: immersing at least a portion of a cell stack within a liquid coolant to manage thermal energy within the cell stack, the cell stack including a plurality of battery cells disposed along a cell stack axis and a plurality of dividers disposed along the cell stack axis, the plurality of dividers each including a sandwiched portion and at least one peripheral portion, the sandwiched portion sandwiched axially between axially adjacent battery cells within the plurality of battery cells; and guiding the liquid coolant using peripheral portions of the plurality of dividers.

In some aspects, the techniques described herein relate to a method, wherein the peripheral portions include a first flange that extends axially in a first axial direction, and a second flange that extends axially in an opposite second axial direction.

In some aspects, the techniques described herein relate to a method, wherein the at least one peripheral portion includes a first peripheral portion that extends above the battery cells of the cell stack, and a second peripheral portion that extends below the battery cells of the cell stack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates a section view at line 3-3 in FIG. 2.

FIG. 4 illustrates a perspective view of a divider from a cell stack of the battery pack of FIG. 2.

FIG. 5 illustrates a close-up view of an end of the divider from FIG. 4.

FIG. 6 illustrates a close-up view of an area of FIG. 3 showing immersion coolant channels extending over a top of the cell stack.

FIG. 7 illustrates a close-up view of an area of FIG. 3 showing immersion coolant channels that extend beneath the cell stack.

FIG. 8 illustrates a perspective view of a divider according to another exemplary aspect of the present disclosure.

FIG. 9 illustrates a close up view of an end of the divider of FIG. 8.

### DETAILED DESCRIPTION

An immersion thermal management system can be used to manage thermal energy in a traction battery pack. The immersion thermal management system immerses at least some components of the traction battery pack in a liquid coolant. The immersed components can include a cell stack. This disclosure is directed toward guiding the liquid coolant through areas of the battery pack to facilitate thermal transfer between the liquid coolant and the components of the battery pack.

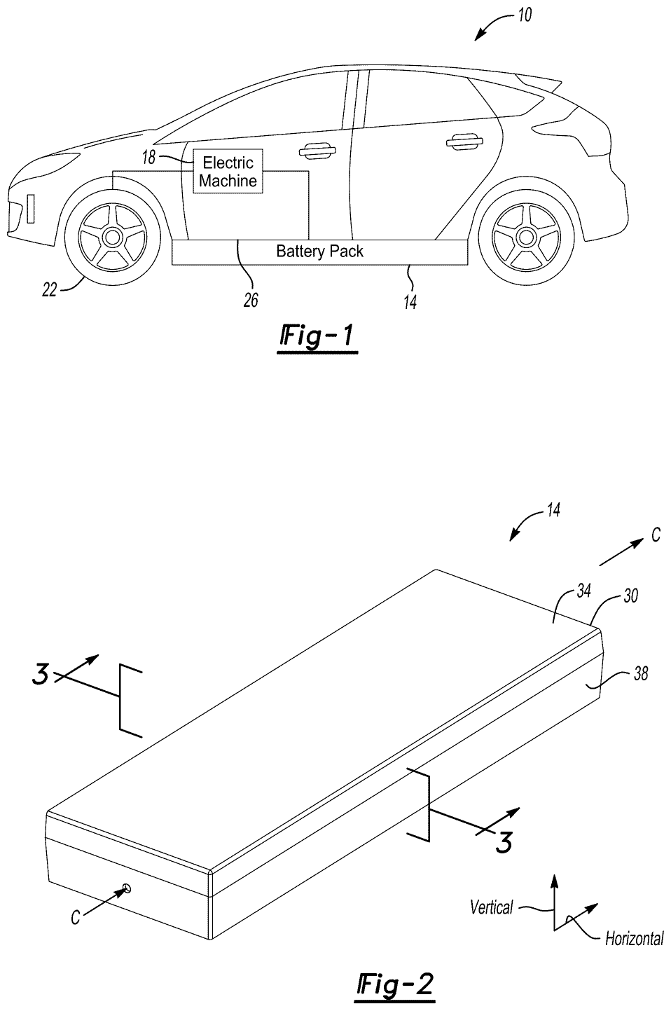

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

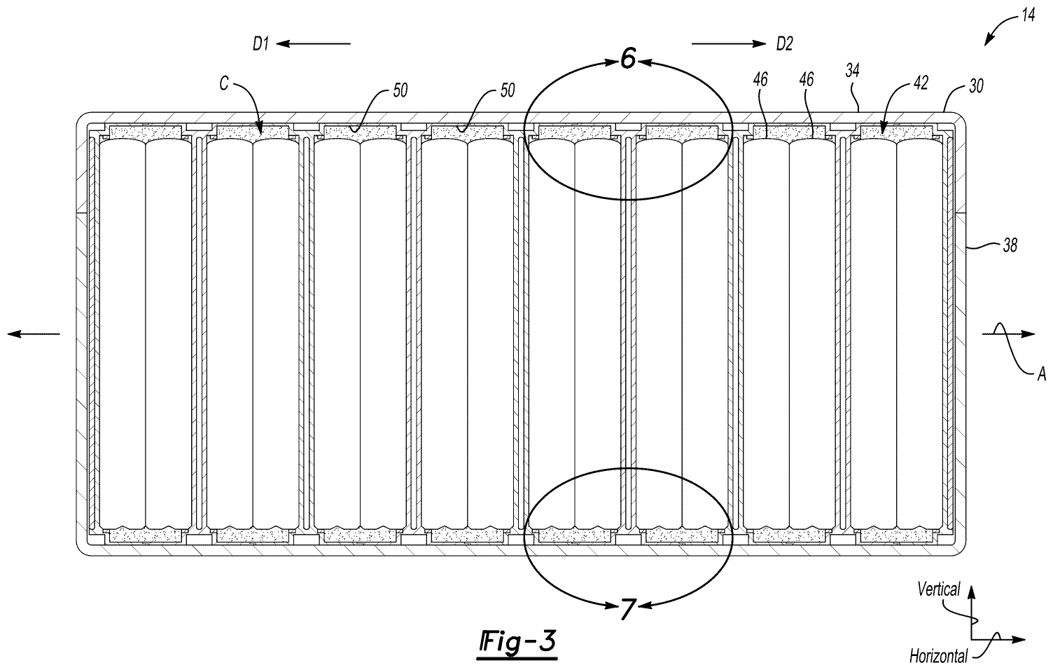

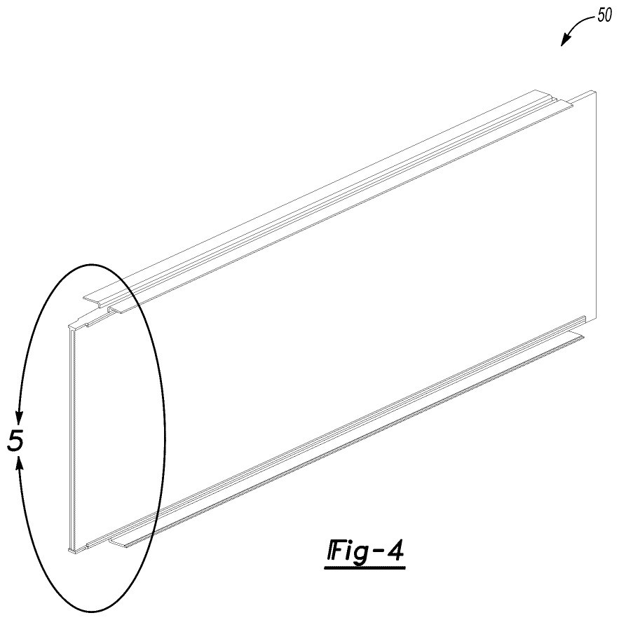

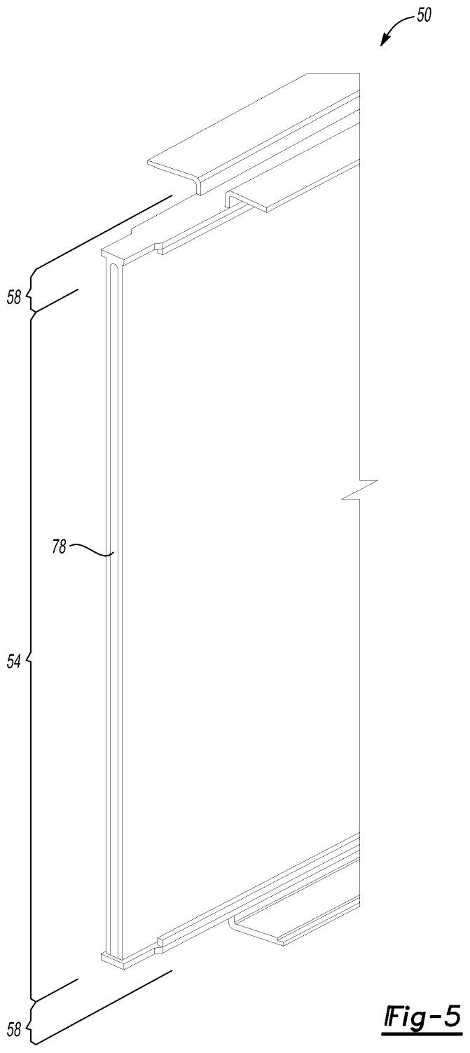

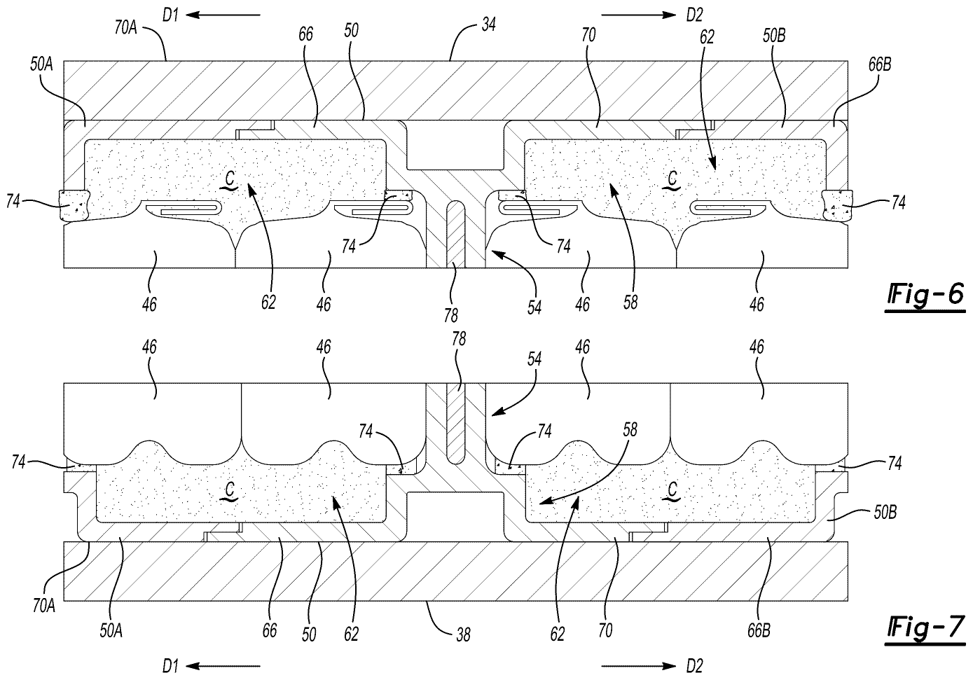

Referring now to FIGS. 2-7, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38. Vertical is with reference to ground and a general orientation of the vehicle 10 and the battery pack 14 during operation. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1.

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, at least one cell stack 42 is housed within the enclosure assembly 30. The cell stack 42 includes a plurality of individual battery cells 46 disposed along a cell stack axis A. The cell stack 42 could include any number of battery cells 46. The battery pack 14 could employ any number of cell stacks 42 within the enclosure assembly 30. Thus, this disclosure is not limited to the exact configuration shown in FIG. 2. Further, while the battery cells 46 of FIG. 2 are positioned side-by-side relative to one another, other configurations are also contemplated within the scope of this disclosure, including but not limited to embodiments in which the battery cells 46 are stacked on top of one another, for example.

The cell stack 42 is arranged in an interior of the enclosure assembly 30 within the tray 38 and beneath the cover 34. A thermal management system is configured to route non-conductive (i.e., dielectric) coolant C through the interior and over areas of the cell stack 42 to manage thermal energy within the cell stack 42 by, for example, using the coolant C to take on heat from the cell stack 42. The thermal management system is an immersion thermal management system at least because portions of the battery pack 14, here at least the battery cells 46 of the cell stack 42 are immersed in the coolant C.

In an embodiment, the battery cells 46 are pouch, lithium-ion cells. However, battery cells having other geometries (cylindrical, prismatic, etc.), other chemistries (nickel-metal hydride, lead-acid, etc.), or both could alternatively be utilized within the scope of this disclosure.

The cell stack 42 further includes a plurality of dividers 50 disposed axially between groups of the battery cells 46 along the cell stack axis A. The plurality of dividers 50 each include a sandwiched portion 54 and at least one peripheral portion 58. The sandwiched portions 54 are sandwiched axially between axially adjacent battery cells 46. The at least one peripheral portions 58 extend outward from the peripheral portion and the cell stack axis A and are disposed outside the battery cells 46. The peripheral portions 58 provide a portion of at least one immersion coolant channel 62.

The example dividers 50 include one peripheral portion 58 extending upward above the battery cells 46 and one peripheral portion 58 extending downward below the battery cells 46. Each peripheral portion 58, in this example, includes a first flange 66 and a second flange 70. The first flange 66 extends in a first axial direction D1 to axially overlap with at least some of the battery cells 46 on a first side of the sandwiched portion 54. The first flange 66 overlaps with the second flange 70A of another divider 50A to establish the immersion coolant channel 62. The first flange 66, the second flange 70A, and the battery cells 46 establish part of one immersion coolant channel 62. In this example, the first flange 66 overlaps with the second flange 70A through a shiplap interface.

The second flange 70 extends in an opposite, second direction D2 to overlap with at least some of the battery cells 46 on an opposite, second side of the sandwiched portion 54, and to further overlap with the first flange 66B of another divider 50B through the shiplap interface. The second flange 70 and the first flange 66B of the other divider 50B together establish part of a different, second immersion coolant channel 62.

In this example, the battery pack 14 includes compression pads 74 that are positioned between the first flanges 66 and the battery cells 46, and between the second flanges 70 and the battery cells 46. The compression pads 74 can be a foam material, for example. The compression pads 74 can help mitigate mechanical friction between the first flanges 66 and the battery cells 46, and between the second flanges 70 and the battery cells 46. The compression pads 74 can be adhesively secured to the battery cells 46, the first flanges 66, the second flanges 70, or some combination of these. The compression pads 74 can facilitate electrically isolating the first flanges 66 and the second flanges 70 from the battery cells 46.

The dividers 50 can be a metal or metal alloy. The dividers 50 can be aluminum, for example. The sandwiched portion 54 and the peripheral portions 58 are part a singular divider structure. In some examples, the dividers 50 are coated with an insulative coating.

In the embodiment shown, the sandwiched portion 54 includes a non-metallic thermal barrier 78 covered by the metal or metal alloy. The non-metallic thermal barrier 78 can be an aerogel or mica, for example. The non-metallic thermal barrier 78 can help to inhibit thermal energy transferring from battery cells 46 on one axial side of the sandwiched portion 54 to battery cells 46 on an opposite side of the sandwiched portion 54. The non-metallic thermal barrier 78 could be injected into the sandwiched portion 54 during assembly of the divider 50.

In this example, the dividers 50 each project laterally outward past the first flanges 66 and the second flanges 70. The dividers 50 can extend horizontally outward to the side walls of the enclosure tray 38. This can help to compartmentalize the battery cells 46 within the enclosure assembly 30 to help block thermal energy from moving axially through the battery pack 14.

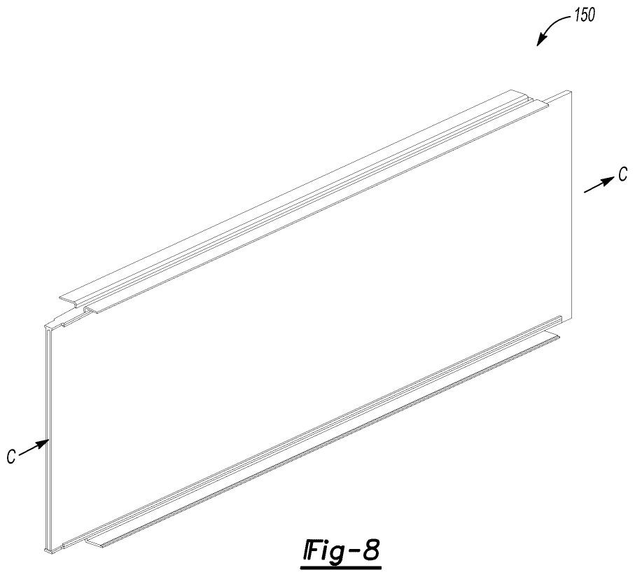

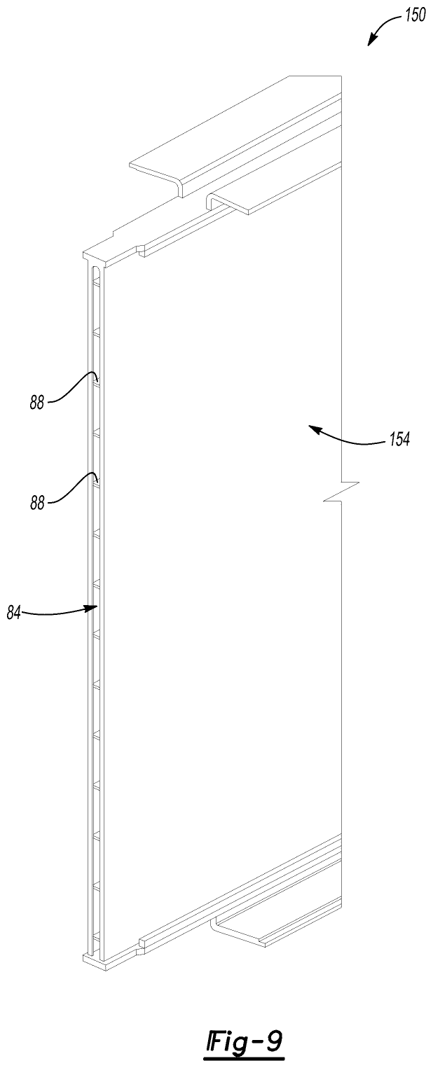

In another example, as shown in FIGS. 8 and 9, a sandwiched portion 154 of another example divider 150 includes a passage 84 that extends through the sandwiched portion 154 and permits immersion coolant to flow through the sandwiched portion 154. A bracing structure 88 can be used to maintain the passage 84 in the sandwiched portion 154 when the sandwiched portion 154 is compressed along the cell stack axis A. The passage 84 provides a immersion coolant channel that communicates a liquid coolant between axially adjacent battery cells 46 on opposing sides of the sandwiched portion 154.

Features of disclosed examples include a system that provides space for immersion coolant flow.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a cell stack within an interior of an enclosure, the cell stack including a plurality of battery cells and a plurality of dividers disposed along a cell stack axis, the plurality of dividers extending outward from the cell stack axis further than the plurality of battery cells to provide a portion of at least one immersion coolant channel.

2. The traction battery pack assembly of claim 1, wherein the plurality of dividers are aluminum.

3. The traction battery pack assembly of claim 1, wherein the plurality of dividers establish the at least one immersion coolant channel above the plurality of battery cells.

4. The traction battery pack assembly of claim 1, further comprising a liquid coolant within the at least one immersion coolant channel.

5. The traction battery pack assembly of claim 1, further comprising an enclosure assembly housing the cell stack.

6. The traction battery pack assembly of claim 1, wherein each divider in the plurality of dividers each include a sandwiched portion and a peripheral portion, the sandwiched portion sandwiched axially between axially adjacent battery cells within the plurality of battery cells, the peripheral portion disposed outside the plurality of battery cells, the peripheral portion providing a portion of the at least one immersion coolant channel.

7. The traction battery pack assembly of claim 6, wherein the peripheral portion axially overlaps with at least some of the plurality of battery cells.

8. The traction battery pack assembly of claim 6, wherein the peripheral portion of a first divider within the plurality of dividers overlaps with a second divider within the plurality of dividers.

9. The traction battery pack assembly of claim 6, wherein the sandwiched portion includes at least one other immersion coolant channel that communicates a liquid coolant between axially adjacent battery cells within the plurality of battery cells.

10. The traction battery pack assembly of claim 6, wherein the sandwiched portion comprises a non-metallic thermal barrier covered by a metal or metal alloy.

11. The traction battery pack assembly of claim 6, wherein the peripheral portion includes a first flange that extends in a first axial direction, and a second flange that extends in an opposite, second axial direction.

12. The traction battery pack assembly of claim 11, further comprising at least one first compression pad disposed between the first flange and the plurality of battery cells, and at least one second compression pad disposed between the second flange and the plurality of battery cells.

13. The traction battery pack assembly of claim 11, wherein the peripheral portion is a first peripheral portion that extends upward past the plurality of battery cells, and further comprising a second peripheral portion that extends downward past the plurality of battery cells, the second peripheral portion including a first flange that extends in the first axial direction, and a second flange that extends in the second axial direction.

14. The traction battery pack assembly of claim 13, wherein the first peripheral portion, the second peripheral portion, and the sandwiched portion are portions of a singular divider structure.

15. The traction battery pack assembly of claim 11, wherein the first flange axially overlaps with a peripheral portion of another divider within the plurality of dividers.

16. The traction battery pack assembly of claim 15, wherein an interface between the first flange and a flange of a peripheral portion of another divider is a shiplap interface.

17. A method of managing thermal energy within a traction battery pack, comprising:
immersing at least a portion of a cell stack within a liquid coolant to manage thermal energy within the cell stack, the cell stack including a plurality of battery cells disposed along a cell stack axis and a plurality of dividers disposed along the cell stack axis, the plurality of dividers each including a sandwiched portion and at least one peripheral portion, the sandwiched portion sandwiched axially between axially adjacent battery cells within the plurality of battery cells; and
guiding the liquid coolant using peripheral portions of the plurality of dividers.

18. The method of claim 17, wherein the peripheral portions include a first flange that extends axially in a first axial direction, and a second flange that extends axially in an opposite second axial direction.

19. The method of claim 17, wherein the at least one peripheral portion includes a first peripheral portion that extends above the plurality of battery cells of the cell stack, and a second peripheral portion that extends below the plurality of battery cells of the cell stack.
